(19) United States
(12) Patent Application Publication
(10) Pub. No.: US 2011/0022452 A1
(43) Pub. Date: Jan. 27, 2011

(54) SPORTING EVENT PROMOTION

(76) Inventors: Conrad R. Carney, II, Lexington, KY (US); James H. Johnson, JR., Lexington, KY (US)

Correspondence Address: KING & SCHICKLI, PLLC, 247 NORTH BROADWAY, LEXINGTON, KY, 40507, US

(21) Appl. No.: 12/841,329

(22) Filed: Jul. 22, 2010

Related U.S. Application Data
(60) Provisional application No. 61/227,530, filed on Jul. 22, 2009.

(51) Int. Cl. G06Q 30/00; G01S 19/42

(52) U.S. Cl. 705/14.5

(57) ABSTRACT

A method of promoting a sporting event via a contest includes the steps of using a global positioning satellite system and a mobile communication device of a subscriber consumer to determine the presence of the subscriber consumer at a particular sporting event and selecting a winner from all subscriber consumers determined to be located and present at the sporting event.

This application claims priority to U.S. Provisional Patent Application Ser. No. 61/227,530 filed 22 Jul. 2009, the entire disclosure of which is incorporated herein by reference.

### TECHNICAL FIELD AND INDUSTRIAL APPLICABILITY OF THE INVENTION

The present invention relates generally to the marketing field and, more particularly, to a method of promoting a sporting event or team utilizing mobile phone text messaging.

### BACKGROUND OF THE INVENTION

The marketing of goods and services by means of mobile phone text messaging is a rapidly growing field. The concept of narrow casting text messages to existing or potential business customers is known. Relevant prior art patents include U.S. Pat. Nos. 6,754,314 to Wengrovitz et al, 7,197,324 to Sweeney and 7,437,413 to Okuyama et al.

The present invention relates to a new and improved method of promoting a sporting event or team using a mobile phone text messaging service.

### SUMMARY OF THE INVENTION

In accordance with the purposes of the present invention as described herein, a method of promoting a sporting event or sports team by means of a contest comprises the steps of using a global positioning satellite system in a mobile communication device of a subscriber consumer to determine the presence of the subscriber consumer at a particular sporting event and selecting a winner of the contest from all subscriber consumers determined to be located and present at the sporting event. The method further includes the step of sending a message to the winner over the mobile communication device of the winner requesting seating information for the winner. Further, the method includes photographing the winner in the seat at the sporting event. Next is the displaying of an image of the winner on a monitor, a scoreboard or both a monitor and a scoreboard at the sporting event. Finally, the method includes awarding a prize to the winner.

In the following description there is shown and described several different embodiments of the invention, simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated herein and forming a part of the specification, illustrate several aspects of the present invention and together with the description serve to explain certain principles of the invention. In the drawings:

FIG. 1 is a schematical block diagram of the method of the present invention; and

FIG. 2 is a schematical block diagram illustrating the relationship between the various entities involved in the target marketing concept of the present invention.

Reference will now be made in detail to the present preferred embodiment of the invention, examples of which are illustrated in the accompanying drawings.

### DETAILED DESCRIPTION OF THE PREFERRED EMBODIMENTS OF THE INVENTION

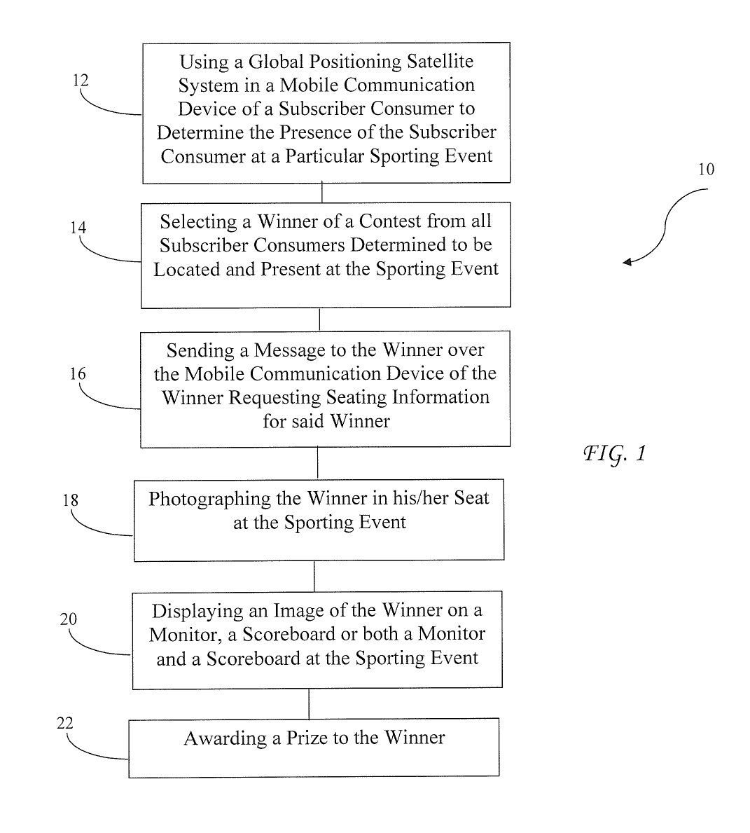

As illustrated in FIG. 1, the present invention relates to a method of promoting a sporting event or sports team by means of a contest. The method (10) may be broadly described as comprising the steps of using (12) a global positioning satellite system and a mobile communication device of a subscriber consumer to determine the presence of the subscriber consumer at a particular sporting event and selecting (14) a winner of the contest from all subscriber consumers determined to be located and present at a particular sporting event. The method (10) further includes sending (16) a message to the winner over the mobile communication device requesting seating information from the winner. Next the method (10) includes photographing (18) the winner in the seat at the sporting event. This is followed by displaying (20) an image of the winner on a monitor, a scoreboard or both a monitor and a scoreboard at the sporting event. Further the method (10) includes awarding (22) a prize to the winner.

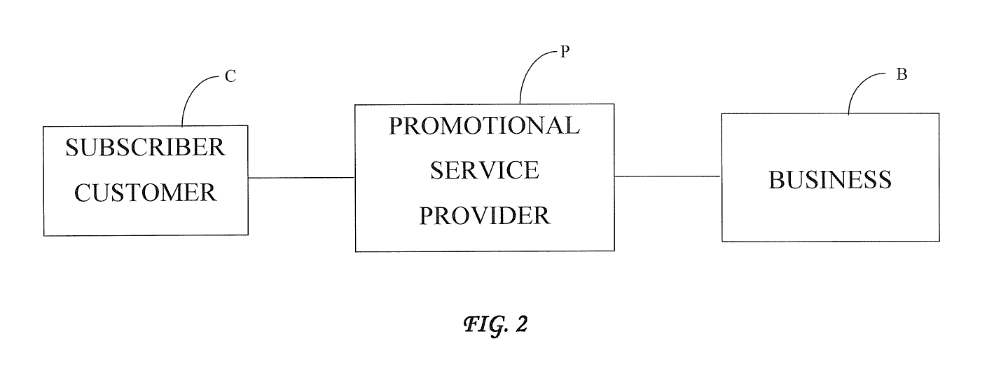

As illustrated in FIG. 2, a promotional service provider P is engaged by a sports team or a producer of a sporting event B to promote the team/event to subscriber customers C. Toward this end, the promotional service provider P utilizes a mobile phone text messaging service. Such a text messaging service is a permission based service requiring the registration of a customer or potential customer C of the sporting event or team B. Two mediums are provided for a customer C to join or subscribe to the text messaging service. The first provides for customer registration via an internet website. The second provides for customer registration via mobile phone texting. Thus, a potential customer or existing customer C may utilize his mobile phone to register via the cell phone registration medium.

In order to register, a customer C provides personal data which is stored in memory by the promotional service provider P. That data includes, but may not necessarily be limited to, residence information including address and mobile phone number. The individual registering is then eligible for the contest at the sporting event and may be determined to be the winner.

In accordance with an additional aspect of the present invention, the mobile phone text messaging service provided by the promotional service provider P includes a global positioning satellite (GPS) monitor. The GPS monitor locates the individual subscriber customer C by monitoring the global positioning satellite or GPS feature of the mobile phone carried by the customer. When the monitor determines that the customer is present at the sporting event, the customer is formally entered into the contest. A winner is then randomly selected from all of the customers C determined to be present at the sporting event for the sport team B. Thus, when it is desired to initiate a promotional contest, the GPS monitor determines which registered, subscriber customers C are actually present at the sporting event. Those subscriber customers C actually present at the sporting event are eligible to win the promotional contest. One or more of those customers C is selected as a winner. A text message is then sent to the winner or winners requesting seating information. The winner sends his or her seating information back to the promoter P. Upon receiving the seating information, the winner is photographed in his or her seat at the sporting event. The winner's photograph or image is displayed on a monitor, a scoreboard or both a monitor and a scoreboard at the sporting event and an optional prize may be awarded.

The current method (10) provides a great way to award patrons of sporting events and teams by publically recognizing their attendance at sporting events and providing optional awards. The text messaging aspect of the method allows the individual winner to be found at their seat at even the most crowded sporting event with minimal difficulty.

All subscriber customers C registering for the contest are maintained on a list by the promotional service provider P. The system also provides the promotional service provider P with the ability to determine how many times a particular customer C has attended a sporting event put on by the promoter or sport team B. This marketing information can also be provided to the promoter or sport team. Thus the list of customers C owned by the promotional service provider P comprises valuable marketing information that increases the value of the service provided by the promotional service provider P to the sporting event producer or sports team B thereby providing the producer or team with an incentive to maintain the service.

The foregoing description of the preferred embodiments of the present invention have been presented for purposes of illustration and description. It is not intended to be exhaustive or to limit the invention to the precise form disclosed. Obvious modifications or variations are possible in light of the above teachings. The embodiments were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims in their fair and broad interpretation in any way.

What is claimed:

1. A method of promoting a sporting event by means of a contest, comprising:
using a global positioning satellite system in a mobile communication device of a subscriber consumer to determine presence of said subscriber consumer at a particular sporting event; and
selecting a winner of the contest from all subscriber consumers determined to be located and present at said sporting event.

2. The method of claim 1, further including sending a message to said winner over said mobile communication device of said winner requesting seating information for said winner.

3. The method of claim 2, including photographing said winner in said seat at said sporting event.

4. The method of claim 3, including displaying an image of said winner on a monitor, a scoreboard or both a monitor and a scoreboard at said sporting event.

5. The method of claim 4, including awarding a prize to said winner.
